(19) United States
(12) Patent Application Publication
(10) Pub. No.: US 2011/0168492 A1
(43) Pub. Date: Jul. 14, 2011

(54) LADDER LEVELER AND STABILIZER

(75) Inventor: ERIC JOHNSON, WOOD VILLAGE, OR (US)

(73) Assignee: THORSTAND LLC, LAKE OSWEGO, OR (US)

(21) Appl. No.: 12/985,702

(22) Filed: Jan. 6, 2011

Related U.S. Application Data
(60) Provisional application No. 61/294,451, filed on Jan. 12, 2010.

(51) Int. Cl. E06C 7/00; E06C 7/18

(52) U.S. Cl. 182/107

(57) ABSTRACT

A ladder leveler and stabilizer that combines both ladder leveling and ladder stabilization. In particular, the ladder leveler and stabilizer levels a ladder on sloping or uneven ground, significantly broadens the ladder base for stability, retrofits to existing ladders without ladder modification, and furthermore is fast to attach/remove, easy to adjust by a single user, readily portable, and compliant with ANSI ladder design standards.

### CROSS-REFERENCE TO RELATED APPLICATIONS

This application claims the benefit of U.S. Provisional Application No. 61/294,451 filed on 2010 Jan. 12 by the present inventor, which is incorporated herein by reference.

### TECHNICAL FIELD

Disclosed embodiments relate to ladder leveler and stabilizer apparatuses.

### BACKGROUND

Ladder falls are a leading industrial safety issue. There are approximately 200,000 ladder related accidents in the United States each year. Standard commercial ladders are inherently unstable due to their narrow base width as well as ladder feet designed for level placement. Often users of these ladders need to lean or carry awkward loads while on ladders placed on uneven ground and this combination can result in the center of gravity of the ladder load extending beyond the ladder feet, thereby placing the user at high risk of a ladder fall.

Numerous ladder leveler designs (e.g. U.S. Pat. No. 5,542,497) disclose extendable ladder feet in order to keep the ladder rails vertical when placed on inclined ground. However, these designs do not significantly widen the ladder base and therefore the ladder remains prone to tipping.

Numerous ladder stabilizer designs (e.g. U.S. Pat. No. 6,527,084) disclose telescoping support feet attached to the ladder rails on one end and in contact with the ground at a distance from the ladder on the other end for stabilization against lateral movement of the ladder. However, these designs are not suitable for stabilization in the case where one of the ladder feet is not in contact with the ground or the ladder rails are not vertical.

U.S. Pat. No. 6,336,521 discloses a ladder leveling device with an arch structure that fails the ANSI/OSHA requirements that the first rung, in this case the arch, is flat and that rung-spacing is twelve inches. Furthermore, since the height of the arch is related to the arch base width and ANSI/OSHA standards require that the first rung is no higher than fourteen inches off the ground, the permissible arch base width is restricted by this constraint, and consequently the stability of the ladder leveling device limited.

U.S. Pat. No. 1,424,934 discloses a ladder leveler for use on hillsides. The aforementioned disclosure reveals a typical application on sloping ground where one of the ladder leveler feet does not extend beyond the ladder rails, and therefore does not add stability to the ladder during normal use. In addition, the ladder leveler is not separable from the ladder, and therefore lacks flexibility in use and transportation.

Most ladder leveler and/or stabilizer designs require permanent ladder modifications (such as drilling of holes) or if designed to retrofit without modification are not readily installed/removed, and additionally their usage often requires that each support leg is adjusted separately, which can be challenging for one person to manage alone.

### SUMMARY

Clearly, there is a need for a combined ladder leveler and stabilizer that levels a ladder on sloping or uneven ground, significantly broadens the ladder base for stability, retrofits to existing ladders without ladder modification, and furthermore is fast to attach/remove, easy to adjust by a single user, readily portable, and compliant with ANSI/OSHA ladder design standards.

Disclosed embodiments of the leveler and stabilizer for a ladder include: a) a base assembly with feet extending beyond the ladder's rails, the feet adapted to stand on a variety of ground surfaces and inclines; b) a ladder harness assembly adapted on one side to attach to the ladder and adapted on the other side to attach to the base assembly by both a ladder harness pivot and a base assembly retainer, the ladder harness pivot for permitting rotation of the ladder harness assembly relative to the base assembly, and the base assembly retainer for preventing separation of the ladder harness assembly from the base assembly; and c) a ladder harness locking mechanism for preventing rotation of the ladder harness assembly relative to the base assembly.

### BRIEF DESCRIPTION OF THE DRAWINGS

Disclosed embodiments are illustrated by way of example, and not by way of limitation, in the figures of the accompanying drawings.

FIG. 1 illustrates a front elevation of an embodiment of the ladder leveler and stabilizer with attached ladder on inclined ground surface.

FIG. 2 illustrates a side elevation of an embodiment of the ladder leveler and stabilizer with attached ladder.

FIG. 3 illustrates a front elevation of an embodiment of the ladder leveler and stabilizer with attached ladder.

FIG. 4 illustrates a rear elevation of an embodiment of the ladder leveler and stabilizer with attached ladder.

FIG. 5 illustrates a front perspective exploded view of an embodiment of the ladder leveler and stabilizer.

FIG. 6 illustrates a rear perspective exploded view of an embodiment of the ladder leveler and stabilizer.

### DETAILED DESCRIPTION

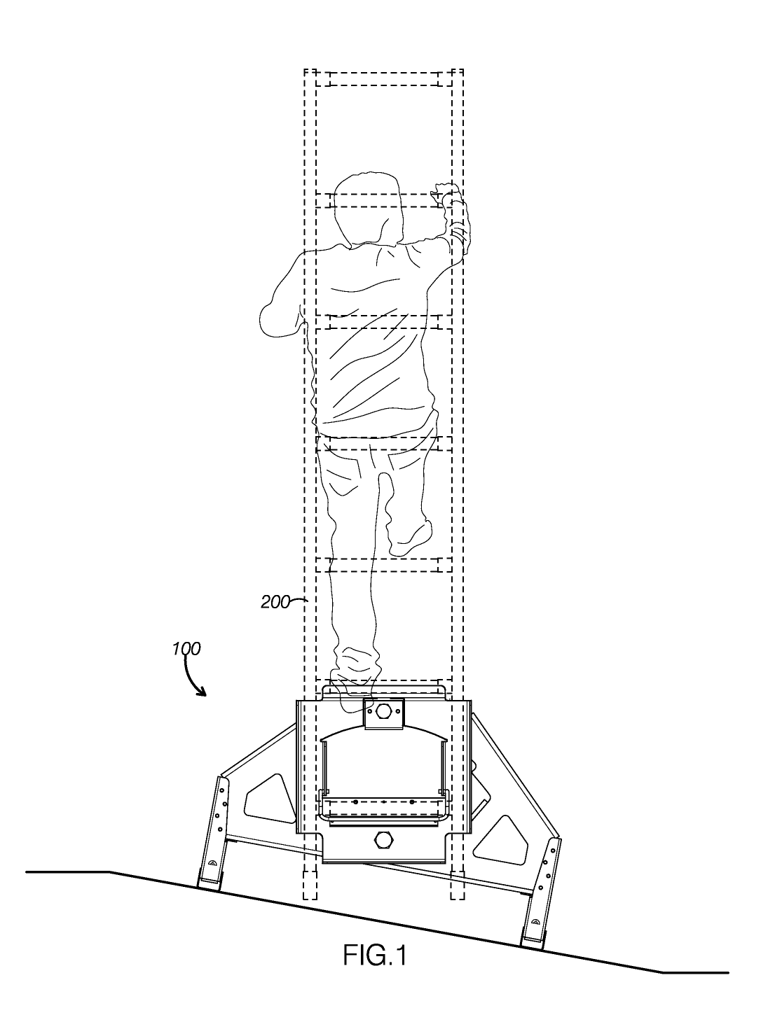

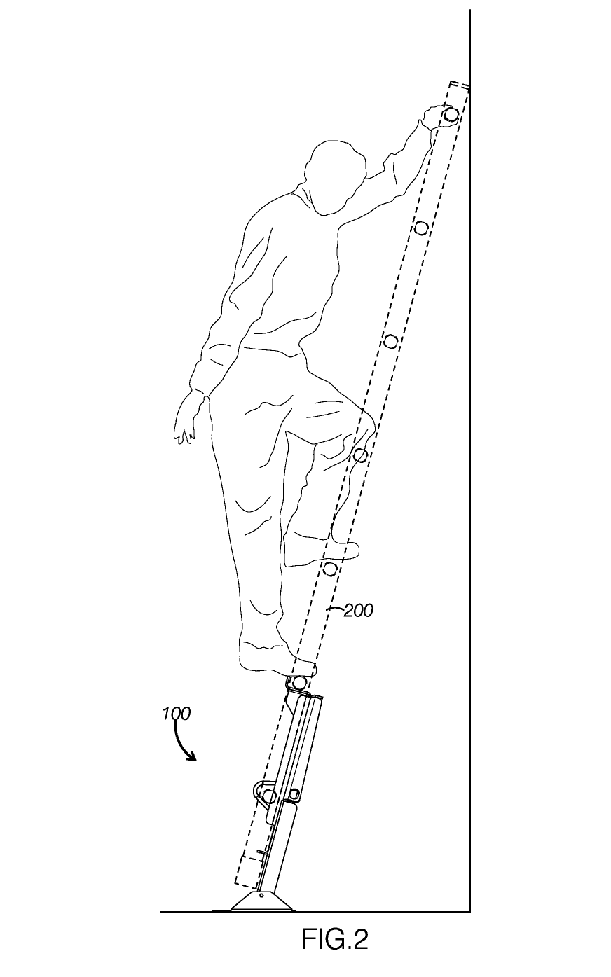

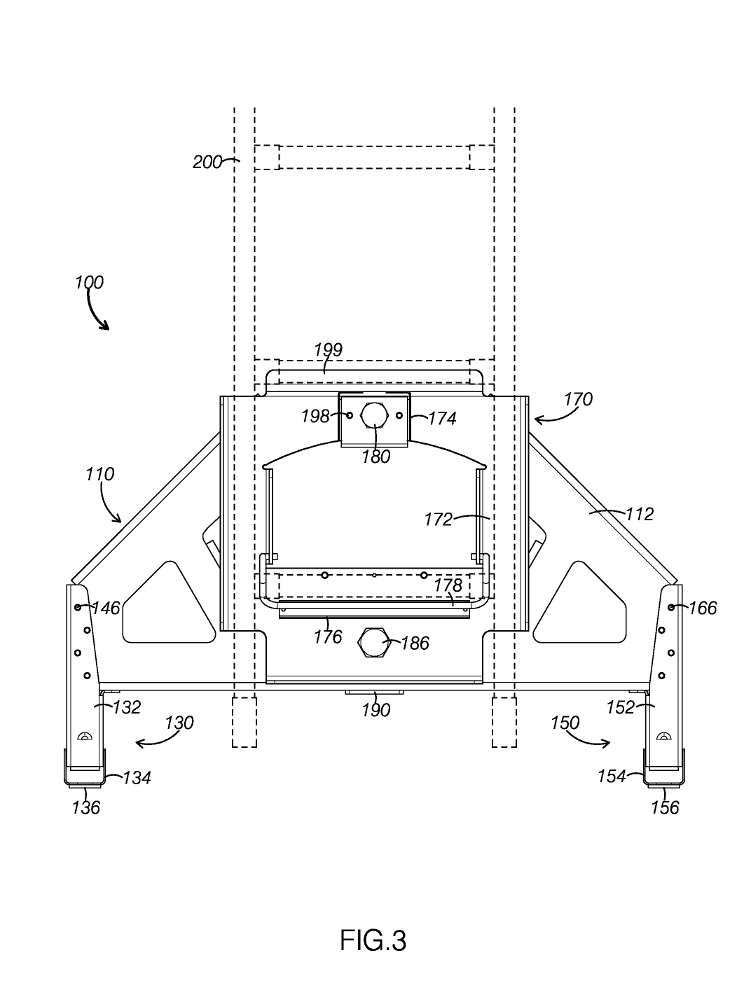

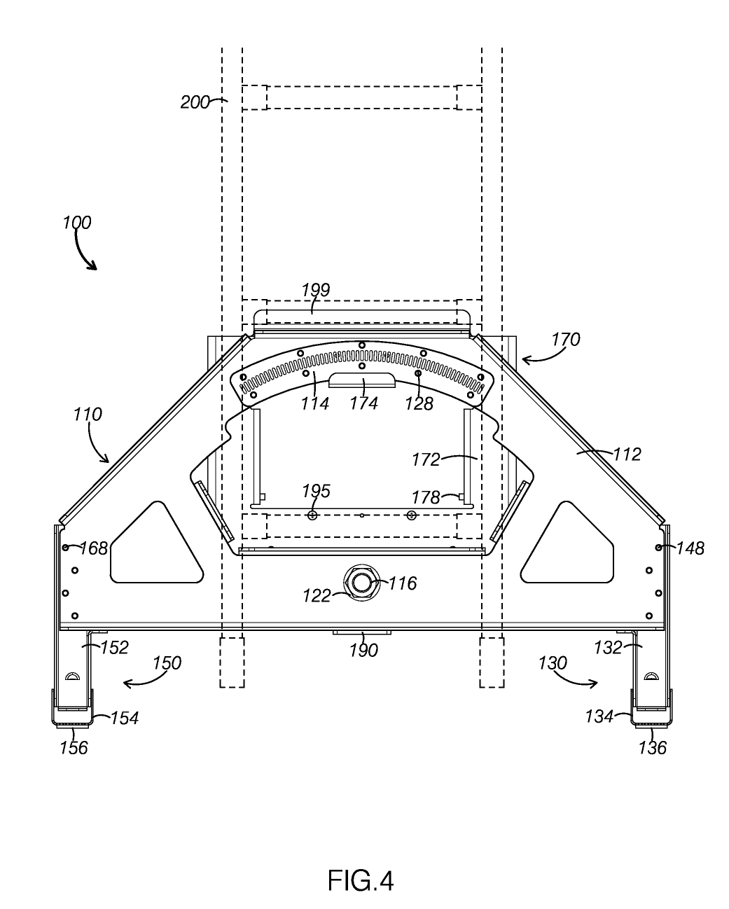

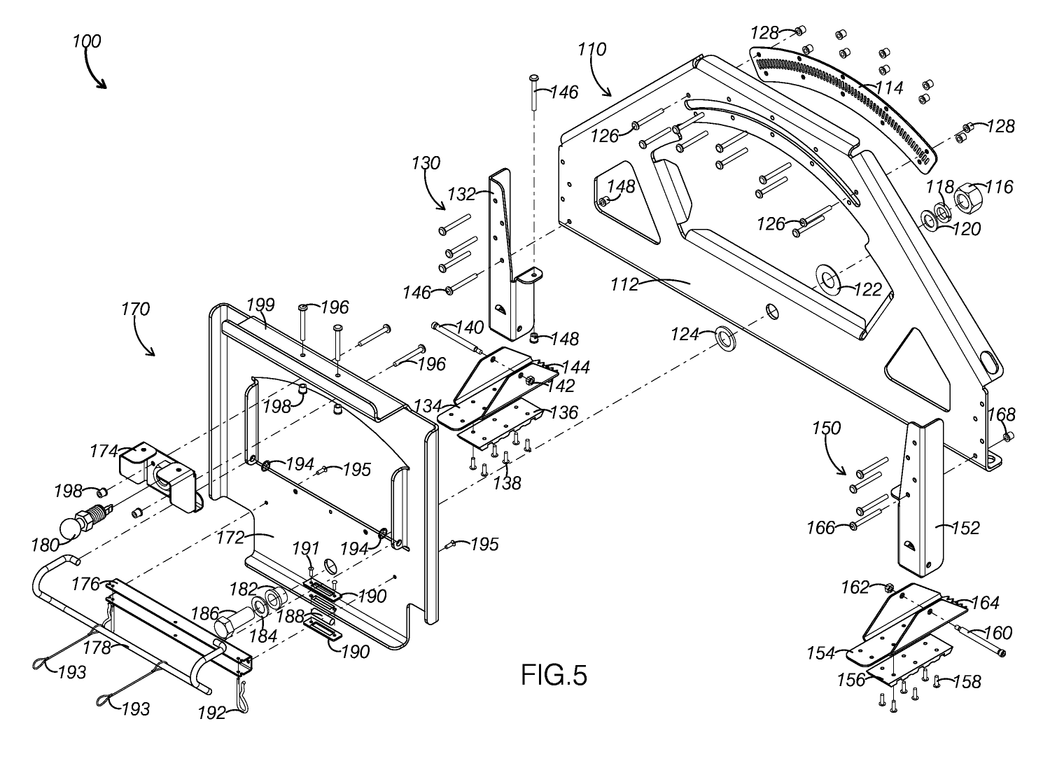

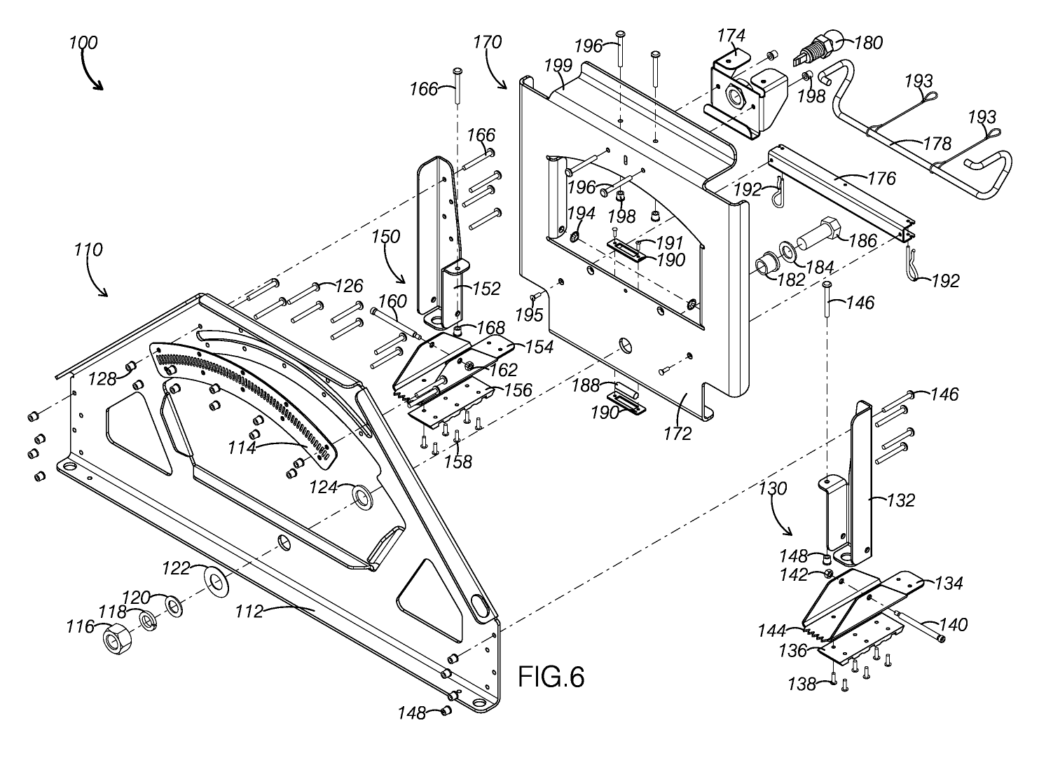

According to one particular embodiment of the ladder leveler and stabilizer (100), shown in FIGS. 1-6, the width of the base assembly (110) is twice the ladder (200) width, which means that the center of gravity of the ladder load must extend beyond the feet (134) before the ladder (200) can fall, and consequently provides a high degree of stability to the ladder (200).

The ladder harness assembly (170), which is attached to the base assembly (110) by the ladder harness pivot (186) and base assembly retainer (174), does not contact the ground and is capable of rotating about the ladder harness pivot (186). The rotatable ladder harness assembly (170), to which the ladder (200) is attached, permits rapid leveling of the ladder (200) on various ground inclines. The ladder harness locking mechanism (180, 114) is designed to allow the ladder harness assembly (170) to lock at specific angles in order to hold the ladder (200) rails vertical. Further, the ladder harness locking mechanism (180, 114) can be engaged and disengaged rapidly without the aid of tools, permitting rapid leveling of the ladder (200) by a single user.

The ladder (200) is securely attached to the ladder harness assembly (170) by the lower rung retainer assembly (178, 176, 192, 193, 195) and the upper rung retainer (199), which attach to the first and second rung of the ladder (200) respectively. Together the lower and upper rung retainers constitute a quick release mechanism for fast attachment/removal of the ladder (200), thus allowing the ladder leveler and stabilizer (100) to be readily used with different ladders as the need arises. Furthermore, ease of separation of the ladder (200) from the ladder leveler and stabilizer (100) facilitates portability of both the ladder (200) and ladder leveler and stabilizer (100).

Ladder stability and vertical rail orientation can be achieved on a variety of ground surfaces and inclines by placing the base assembly (110) on a ground surface, mounting the ladder (200) onto the ladder harness assembly (170), rotating the ladder harness assembly (170) to achieve vertical ladder rail orientation, and locking the ladder harness assembly (170) to maintain vertical ladder rail orientation.

The overlapping central cutout in the base assembly (110) and ladder harness assembly (170) permits a ladder user's foot to be placed onto the first rung of the ladder (200) without obstruction. The second rung of the ladder (200) clears the top of the upper rung retainer (199) and placement of a user's foot on that rung is unimpeded. Consequently, this design does not alter the distance between the first and second ladder (200) rungs and thus complies with ANSI/OSHA ladder requirements regarding ladder rung spacing. Further, the height of the first rung of the ladder (200) above level ground is no higher than fourteen inches and thus complies with ANSI/OSHA ladder requirements regarding ladder first rung height. Indeed, the ladder leveler and stabilizer (100) meets or exceeds all relevant ANSI A14 ladder requirements for ladders type III through IA.

According to the embodiment shown in FIGS. 1-6, the leg assemblies (130, 150) include leg struts (132), leg strut fasteners (146, 148) for attachment of the leg assemblies (130, 150) to the base assembly (110), feet (134), feet pivots (140), feet pivot retainers (142), foot pads (136), and foot pad fasteners (138). The feet (134) have a serrated edge (144) to provide additional grip when the ladder leveler and stabilizer (100) is mounted on soft surfaces.

The upper rung retainer (199) is a support bracket for supporting the ladder load and laterally retaining the second rung of the ladder. The upper rung retainer (199) is braced by the base assembly retainer (174) and the ladder harness assembly (170) to which it attaches. The lower rung retainer assembly (178, 176, 192, 193, 195) comprises the lower rung retainer wire clip (178) in order to laterally retain the first rung of the ladder (200), the lower rung retainer channel (176), the lower rung retainer cotter pins (192) to retain the lower rung retainer wire clip (178) in the lower rung retainer channel (176), the lower rung retainer cables (193) for attachment to lower rung retainer cotter pins (192), the lower rung retainer wire clip fasteners (194) for securing the ends of the lower rung retainer wire clip (178), and the lower rung retainer fasteners (195) for attachment of the lower rung retainer channel (176) to the ladder harness assembly (170).

The base assembly retainer (174) allows the ladder harness assembly (170) to rotate about the ladder harness pivot (186) without the top portion of the ladder harness assembly (170) separating from the base assembly (110), thus relieving rotational stress on the ladder harness pivot (186). Base assembly retainer fasteners (196, 198) attach the base assembly retainer (174) to the ladder harness assembly (170).

The ladder harness locking mechanism (180, 114) comprises the spring-loaded plunger (180) that affixes to the base assembly retainer (174), and a locking plate (114) that affixes to the base assembly (110) with locking plate fasteners (126, 128). The locking plate (114) has multiple slots for capturing the retractable end of the spring-loaded plunger (180). The ladder harness locking mechanism (180, 114) is designed to permit ladder (200) leveling on ground inclinations up to 30 degrees.

The ladder harness pivot (186) and ladder harness pivot fasteners (182, 184, 124, 122, 118, 120, 116) attach the ladder harness assembly (170) and base assembly (110) and permit the ladder harness assembly (170) to rotate relative to the base assembly (110).

The bubble level (188), which serves as a user aid for leveling the ladder (200), is retained between the bubble level plates (190) and secured with bubble level fasteners (191).

According to the embodiment shown in the FIGS. 1-6 the ladder leveler and stabilizer (100) is constructed of lightweight aluminum with the exception of the high stress components and the rubber foot pads (136). Steel components include the locking mechanism (180, 114), ladder harness pivot (186), leg assemblies (130, 150), base assembly retainer (174), lower rung retainer wire clip (178), and fasteners.

The ladder leveler and stabilizer (100) of the aforementioned embodiment fits aluminum and fiberglass extension ladders of lengths up to 32 feet, encompassing approximately ninety percent of commercial extension ladders.

Alternate embodiments of the base assembly (110) include base assemblies of different widths to accommodate different applications.

Alternative embodiments of the leg assemblies (130, 150) include telescoping leg struts in order to provide ladder stability and leveling on steps.

Alternative embodiments of the feet (134) include feet with holes to permit the feet (134) to be easily staked into soft, slippery, or inclined ground for additional safety.

While particular embodiments have been described, it is understood that, after learning the teachings contained in this disclosure, modifications and generalizations will be apparent to those skilled in the art without departing from the spirit of the disclosed embodiments. It is noted that the foregoing embodiments and examples have been provided merely for the purpose of explanation and are in no way to be construed as limiting. While the apparatus has been described with reference to various embodiments, it is understood that the words which have been used herein are words of description and illustration, rather than words of limitation. Further, although the system has been described herein with reference to particular means, materials and embodiments, the actual embodiments are not intended to be limited to the particulars disclosed herein; rather, the system extends to all functionally equivalent structures, methods and uses, such as are within the scope of the appended claims. Those skilled in the art, having the benefit of the teachings of this specification, may effect numerous modifications thereto and changes may be made without departing from the scope and spirit of the disclosed embodiments in its aspects.

The invention claimed is:

1. A leveler and stabilizer for a ladder, comprising:
a) a base assembly with feet extending beyond said ladder's rails, said feet adapted to stand on a variety of ground surfaces and inclines;
b) a ladder harness assembly adapted on one side to attach to said ladder and adapted on the other side to attach to said base assembly by both a ladder harness pivot and a base assembly retainer, said ladder harness pivot for permitting rotation of said ladder harness assembly relative to said base assembly, and said base assembly retainer for preventing separation of said ladder harness assembly from said base assembly; and
c) a ladder harness locking mechanism for preventing rotation of said ladder harness assembly relative to said base assembly.

2. The leveler and stabilizer of claim 1, wherein said ladder harness assembly removably attaches to said ladder.

3. The leveler and stabilizer of claim 2, wherein said feet extend beyond said ladder's rails during normal use.

4. The leveler and stabilizer of claim 3, wherein the distance between said feet is at least one and a half times ladder width.

5. The leveler and stabilizer of claim 4, wherein said feet are adapted to swivel, whereby said feet have stable contact with a ground surface sloping in crosswise directions.

6. The leveler and stabilizer of claim 4, wherein said ladder harness locking mechanism comprises a spring-loaded plunger attached to said ladder harness assembly and a locking plate mounted on said base assembly with a plurality of slots for capturing the retractable end of said spring-loaded plunger.

7. The leveler and stabilizer of claim 4, wherein said ladder harness assembly comprises a lower rung retainer assembly and an upper rung retainer, whereby the first and second rungs of said ladder can be removably attached to said ladder harness assembly.

8. The leveler and stabilizer of claim 7, wherein said lower rung retainer assembly comprises a lower rung retainer wire clip adapted to laterally retain said first rung of said ladder.

9. The leveler and stabilizer of claim 7, wherein said upper rung retainer comprises a support bracket adapted to laterally retain said second rung of said ladder and support ladder load.
